(19) United States
(12) Patent Application Publication
(10) Pub. No.: US 2018/0136860 A1
(43) Pub. Date: May 17, 2018

(54) SEMICONDUCTOR MEMORY DEVICE

(71) Applicant: SK hynix Inc., Icheon-si (KR)

(72) Inventor: Sang Oh LIM, Icheon-si (KR)

(73) Assignee: SK hynix Inc., Icheon-si (KR)

(21) Appl. No.: 15/471,525

(22) Filed: Mar. 28, 2017

(30) Foreign Application Priority Data
Nov. 11, 2016 (KR) 1020160150415

(51) Int. Cl. G06F 3/06; G06F 12/0875; G06F 13/16

(52) U.S. Cl. CPC G06F 3/0619; G06F 3/065; G06F 2212/452; G06F 12/0875; G06F 13/1673; G06F 3/068

(57) ABSTRACT

Provided herein may be a semiconductor memory device. The semiconductor memory device may include a memory cell array including a plurality of memory cells, and a peripheral circuit disposed under the memory cell array. The peripheral circuit may include a bit line contact region electrically coupled to the memory cell array, a first page buffer group disposed on a first side portion of the bit line contact region, and a second page buffer group disposed on a second side portion of the bit line contact region.

### CROSS-REFERENCE TO RELATED APPLICATION

The present application claims priority under 35 U.S.C. § 119(a) to Korean patent application number 10-2016-0150415 filed on Nov. 11, 2016 in the Korean Intellectual Property Office, the entire disclosure of which is incorporated herein by reference.

### BACKGROUND

### 1. Technical Field

Various embodiments of the present disclosure generally relate to an electronic device, and more particularly, to a semiconductor memory device.

### 2. Related Art

Semiconductor devices, in particular, semiconductor memory devices are classified into a volatile memory device and a nonvolatile memory device.

The nonvolatile memory devices can maintain data stored therein even when a supply of power is interrupted, although read and write speeds are comparatively low. Therefore, nonvolatile memory devices are used when there is a need for storing data which must be maintained regardless of whether power is supplied. Representative examples of nonvolatile memory devices include read-only memory (ROM), mask ROM (MROM), programmable ROM (PROM), erasable programmable ROM (EPROM), electrically erasable programmable ROM (EEPROM), flash memory, phase-change random access memory (PRAM), magnetic RAM (MRAM), resistive RAM (RRAM), Ferroelectric RAM (FRAM), etc. Flash memory is classified into NOR type memory and NAND type memory.

Flash memory has advantages of both RAM and ROM types. In RAM, data is programmable and erasable. In ROM, data may be stored therein and retained even when power is interrupted. Such a flash memory may be widely used as a storage medium of portable electronic devices such as a digital camera, a personal digital assistant (PDA), and an MP3 player.

Flash memory devices may be classified into a two-dimensional semiconductor device in which strings are horizontally formed on a semiconductor substrate, and a three-dimensional semiconductor device in which strings are vertically formed on the semiconductor substrate.

### SUMMARY

Various embodiments of the present disclosure are directed to a semiconductor memory device which may improve the integration of the semiconductor memory device and also secure a distance between wires.

An embodiment of the present disclosure may provide for a semiconductor memory device. The semiconductor memory device may include: a memory cell array including a plurality of memory cells; and a peripheral circuit disposed under the memory cell array. The peripheral circuit may include: a bit line contact region electrically coupled to the memory cell array; a first page buffer group disposed on a first side portion of the bit line contact region; and a second page buffer group disposed on a second side portion of the bit line contact region.

An embodiment of the present disclosure may provide for a semiconductor memory device. The semiconductor memory device may include: a peripheral circuit disposed in a peripheral circuit region formed on a semiconductor substrate; and a memory cell array disposed over the peripheral circuit region. The peripheral circuit may include: a bit line contact region electrically coupled to the memory cell array; a first page buffer group and a second page buffer group respectively disposed on opposite sides of the bit line contact region; and a first column select circuit formed in a region adjacent to the first page buffer group, and a second column select circuit formed in a region adjacent to the second page buffer group.

### BRIEF DESCRIPTION OF THE DRAWINGS

Example embodiments will now be described more fully hereinafter with reference to the accompanying drawings; however, the example embodiments may be embodied in different forms and should not be construed as limited to the embodiments set forth herein. Rather, these embodiments are provided so that this disclosure will be thorough and complete, and will fully convey the scope of example embodiments to those skilled in the art.

In the drawing figures, dimensions may be exaggerated for clarity of illustration. It will be understood that when an element is referred to as being “between” two elements, the element can be the only element between the two elements, or one or more intervening elements may also be present. Like reference numerals refer to like elements throughout.

FIG. 1 is a block diagram illustrating a semiconductor memory device according to an embodiment of the present disclosure;

FIG. 2 is a view illustrating a configuration of the semiconductor memory device to describe arrangement of a memory cell array and peripheral circuits;

FIG. 3 is a block diagram illustrating an embodiment of a memory cell array of FIG. 1;

FIG. 4 is a three-dimensional view illustrating a memory string included in a memory block according to the present disclosure;

FIG. 5 is a circuit diagram illustrating the memory string shown in FIG. 4;

FIG. 6 is a block diagram illustrating arrangement of peripheral circuits according to an embodiment of the present disclosure;

FIG. 7 is a block diagram illustrating arrangement of peripheral circuits according to an embodiment of the present disclosure;

FIG. 8 is a block diagram illustrating a memory system including the semiconductor memory device of FIG. 1;

FIG. 9 is a block diagram illustrating an example application of the memory system of FIG. 8;

FIG. 10 is a block diagram illustrating a computing system including the memory system illustrated with reference to FIG. 9.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey a scope of example embodiments to those skilled in the art.

In the drawing figures, dimensions may be exaggerated for clarity of illustration. It will be understood that when an element is referred to as being “between” two elements, the element can be the only element between the two elements, or one or more intervening elements may also be present.

Hereinafter, embodiments will be described with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but the terms should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

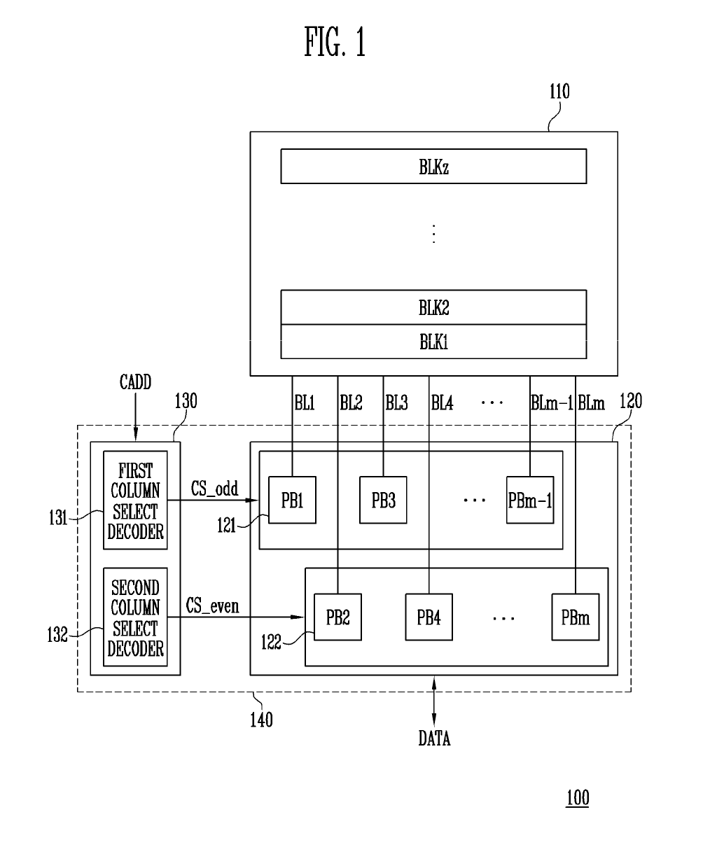

FIG. 1 is a block diagram illustrating a semiconductor memory device according to an embodiment of the present disclosure.

Referring to FIG. 1, a semiconductor memory device 100 includes a memory cell array 110 and a peripheral circuit 140.

The memory cell array 110 includes a plurality of memory blocks BLK1 to BLKz. The memory blocks BLK1 to BLkz are coupled to the peripheral circuit 140 through bit lines BL1 to BLm. Each of the memory blocks BLK1 to BLKz includes a plurality of memory cells. In an embodiment, the memory cells are nonvolatile memory cells, and in particular, the memory cells may be charge trap device based nonvolatile memory cells. A plurality of memory cells which are coupled in common to a single word line may be defined as one page. The memory cell array 110 is formed of a plurality of pages. In addition, each of the memory blocks BLK1 to BLKz of the memory cell array 110 includes a plurality of memory strings. Each of the memory strings includes a drain select transistor, a plurality of memory cells, and a source select transistor which are coupled in series between a bit line and a source line.

The peripheral circuit 140 may include a page buffer circuit 120 and a column decoder 130.

The page buffer circuit 120 includes a plurality of page buffers PB1 to PBm. The plurality of page buffers PB1 to PBm are coupled to the memory cell array 110 through the bit lines BL1 to BLm. The plurality of page buffers PB1 to PBm may be divided into a first page buffer group 121 and a second page buffer group 122 according to the order of an arrangement of the bit lines coupled thereto. For example, the first page buffer group 121 may include page buffers (PB1, PB3, . . . , PBm−1) electrically coupled to odd bit lines (BL1, BL3, . . . , BLm−1). The second page buffer group 122 may include page buffers (PB2, PB4, . . . , PBm) electrically coupled to even bit lines (BL2, BL4, . . . , BLm).

During a program operation, each of the page buffers (PB1, PB3, . . . , PBm−1) included in the first page buffer group 121 may temporarily store data DATA to be inputted from outside the peripheral circuit 140 in response to first column select signals CS_odd and control a potential level of a corresponding one of the bit lines (BL1, BL3, . . . , BLm−1) in accordance with a temporarily stored data value. Furthermore, during a read operation, the page buffers (PB1, PB3, . . . , PBm−1) included in the first page buffer group 121 sense program states of the corresponding memory cells coupled to the bit lines (BL1, BL3, . . . , BLm−1), temporarily store the program states, and outputs temporarily-stored data outside the peripheral circuit 140 in response to first column select signals CS_odd.

During a program operation, each of the page buffers (PB2, PB4, . . . , PBm) included in the second page buffer group 122 may temporarily store data DATA inputted from outside the peripheral circuit 140 in response to second column select signals CS_even and control a potential level of a corresponding one of the bit lines (BL2, BL4, . . . , BLm) in accordance with a temporarily stored data value. Furthermore, during a read operation, the page buffers (PB2, PB4, . . . , PBm) included in the second page buffer group 122 sense program states of the corresponding memory cells coupled to the bit lines (BL2, BL4, . . . , BLm), temporarily store the program states, and output temporarily-stored data outside the peripheral circuit 140 in response to second column select signals CS_even.

The first page buffer group 121 and the second page buffer group 122 are disposed on sides opposite to each other based on a bit line contact region. This configuration will be described in detail later herein.

The column decoder 130 generates and outputs the first column select signals CS_odd and the second column select signals CS_even in response to column address signals CADD.

The column decoder 130 includes a first column select circuit or first column select decoder 131, and a second column select circuit or second column select decoder 132. In an embodiment, the first column select decoder 131 generates the first column select signals CS_odd in response to odd addresses among the column address signals CADD, and outputs the first column select signals CS_odd to the first page buffer group 121. The second column select decoder 132 generates the second column select signals CS_even in response to even addresses among the column address signals CADD, and outputs the second column select signals CS_even to the second page buffer group 122.

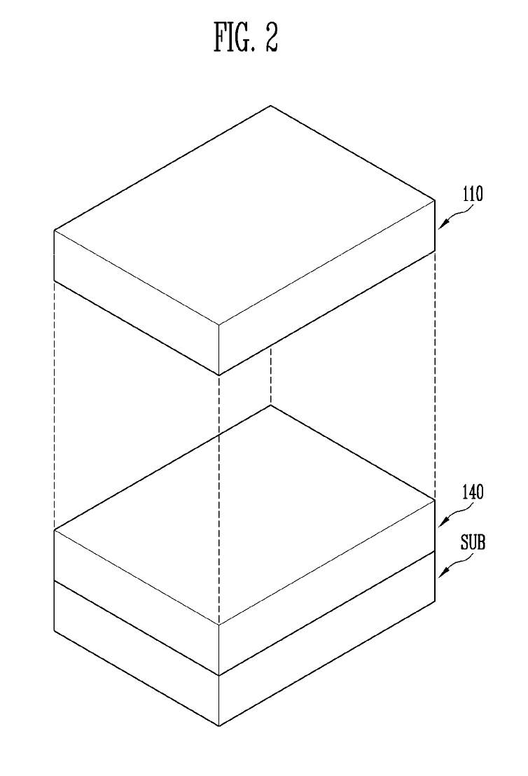

FIG. 2 is a view illustrating a configuration of the semiconductor memory device to describe an arrangement of a memory cell array and peripheral circuits.

Referring to FIG. 2, the peripheral circuit 140 according to an embodiment of the present disclosure is disposed under the memory cell array 110. That is, the peripheral circuit 140 is disposed in a peripheral circuit region formed on a semiconductor substrate SUB, and the memory cell array 110 is disposed over the peripheral circuit 140. Therefore, an area required to embody the structure in which the memory cell array 110 is disposed over the peripheral circuit 140 is reduced compared to an example in which the memory cell array 110 is disposed on the same layer as that of the peripheral circuit 140. Thereby, the integration of the memory device is improved.

The memory cell array 110 may be electrically coupled to the peripheral circuit 140 through a plurality of wires. In an embodiment, the bit lines of the memory cell array 110 may be coupled to the page buffer circuit included in the peripheral circuit 140 through contact plugs and the wires.

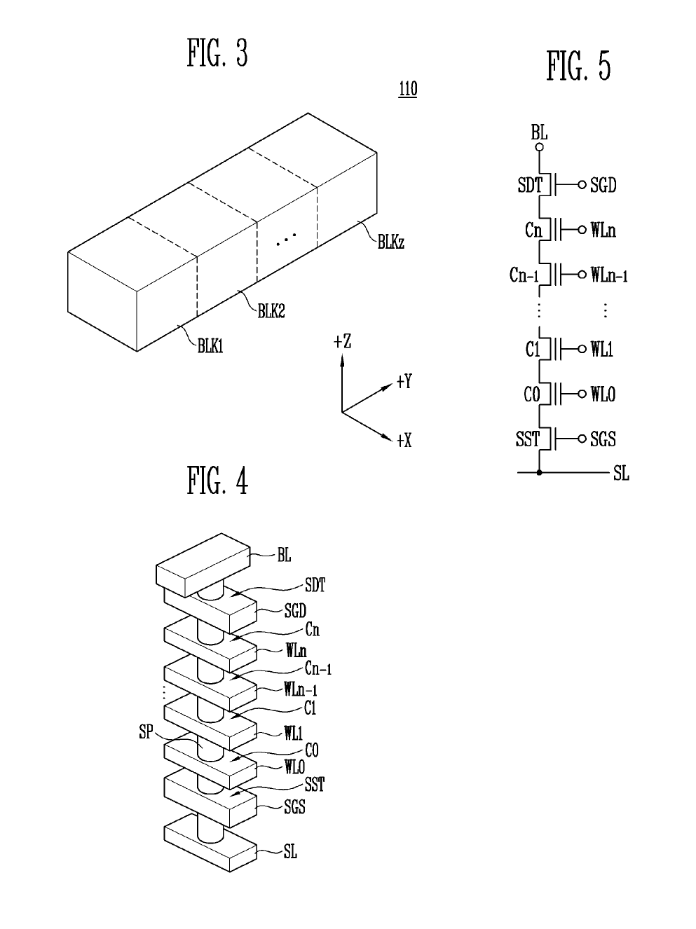

FIG. 3 is a block diagram illustrating an embodiment of the memory cell array of FIG. 1.

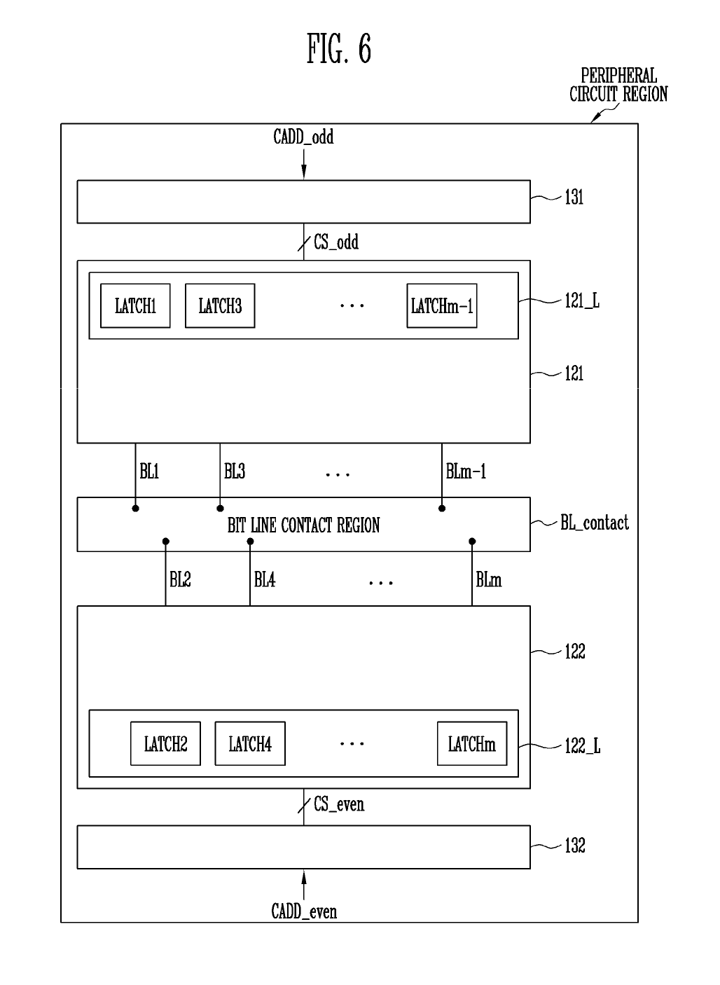

Referring to FIG. 3, the memory cell array 110 includes a plurality of memory blocks BLK1 to BLKz. Each memory block has a three-dimensional structure. Each memory block includes a plurality of memory cells stacked on a substrate. The memory cells are arranged in +X, +Y, and +Z directions. The structure of each memory block will be described in more detail with reference to FIGS. 4 and 5.

FIG. 4 is a three-dimensional view illustrating a memory string included in a memory block according to the present disclosure. FIG. 5 is a circuit diagram illustrating the memory string.

Referring to FIGS. 4 and 5, the source line SL is formed on the semiconductor substrate. A vertical channel layer SP is formed on the source line SL. An upper portion of the vertical channel layer SP is coupled to a corresponding bit line BL. The vertical channel layer SP may be made of polysilicon. A plurality of conductive layers SGS, WL0 to WLn, and SGD are formed at different heights on the vertical channel layer SP in such a way each of the conductive layers SGS, WL0 to WLn, and SGD encloses the vertical channel layer SP. Multi-layers (not shown) including a charge storage layer are formed on a surface of the vertical channel layer SP. The multi-layers are also disposed between the vertical channel layer SP and the conductive layers SGS, WL0 to WLn, and SGD. The multi-layers may be formed of an ONO structure in which an oxide layer, a nitride layer, and an oxide layer are successively stacked. The conductive layers WL0 to WLn may be defined as word lines. The conductive layer SGS may be defined as a source select line coupled to a source select transistor SST. The conductive layer SGD may be defined as a drain select line coupled to a drain select transistor SDT.

The lowermost conductive layer forms the source select line (or a first select line) SGS. The uppermost conductive layer forms the drain select line (or a second select line) SGD. The conductive layers disposed between the select lines SGS and SGD form the respective word lines WL0 to WLn. In other words, the conductive layers SGS, WL0 to WLn, and SGD are formed in a multi-layer structure on the semiconductor substrate. The vertical channel layer SP passing through the conductive layers SGS, WL0 to WLn, and SGD is vertically coupled between the bit line BL and the source line SL formed on the semiconductor substrate.

The drain select transistor SDT is formed on a portion of the uppermost conductive layer SGD that encloses the vertical channel layer SP. The source select transistor SST is formed on a portion of the lowermost conductive layer SSL that encloses the vertical channel layer SP. Memory cells CO to Cn are formed on portions of the intermediate conductive layers WL0 to WLn that enclose the vertical channel layer SP.

In this way, the memory string includes the source select transistor SST, the memory cells CO to Cn, and the drain select transistor SDT, which are vertically coupled to the substrate between the source line SL and the bit line BL. The source select transistor SST electrically couples the memory cells CO to Cn to the source line SL according to a first select signal applied to the first select line SGS. The drain select transistor SDT electrically couples the memory cells CO to Cn to the bit line BL according to a second select signal applied to the second select line SGD.

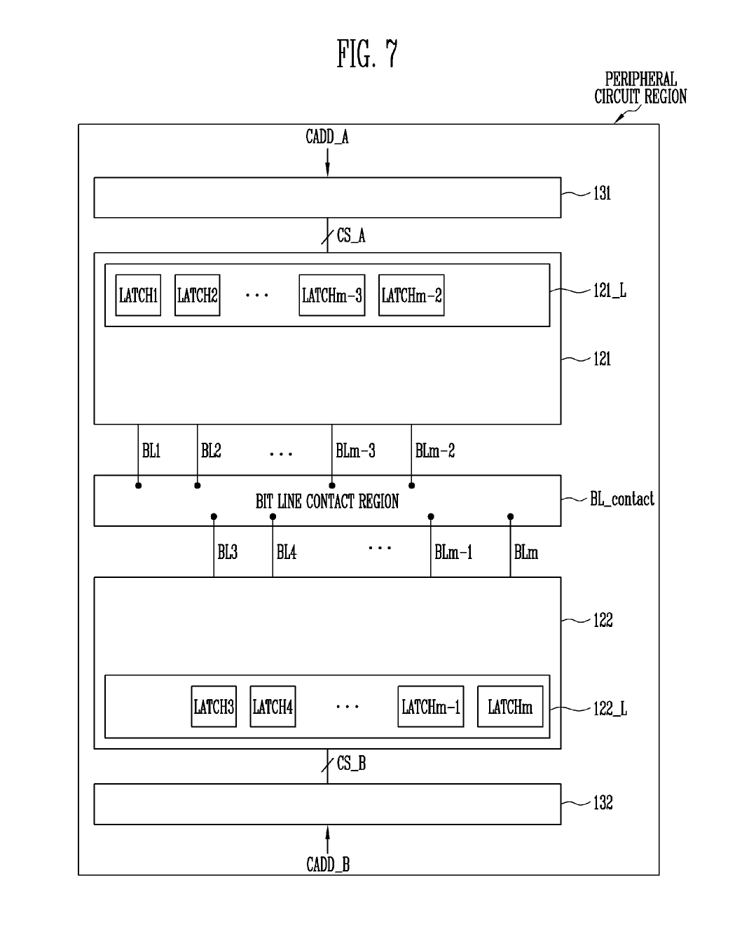

FIG. 6 is a block diagram illustrating an arrangement of peripheral circuits according to an embodiment of the present disclosure.

Referring to FIG. 6, the first page buffer group 121, the second page buffer group 122, the first column select decoder 131, and the second column select decoder 132 that are included in the peripheral circuit 140 are disposed in a peripheral circuit region. In an embodiment, the peripheral circuit region is disposed under the memory cell array as shown in FIG. 2.

A bit line contact region BL_contact electrically coupled with the bit lines of the memory cell array is disposed in a center portion of the peripheral circuit region.

The first page buffer group 121 and the second page buffer group 122 are disposed to face each other on opposite sides of the bit line contact region BL_contact, and the first column select decoder 131 and the second column select decoder 132 are disposed to face each other on opposite sides of the bit line contact region BL_contact. That is, the first page buffer group 121 and the first column select decoder 131 are disposed on a first side portion of the bit line contact region BL_contact. The second page buffer group 122 and the second column select decoder 132 are disposed on a second side portion of the bit line contact region BL_contact opposite to the first side.

The first page buffer group 121 is electrically coupled with the odd bit lines (BL1, BL3, . . . , BLm−1) through the bit line contact region BL_contact. The second page buffer group 122 is electrically coupled with the even bit lines (BL2, BL4, . . . , BLm) through the bit line contact region BL_contact.

According to an embodiment of the present disclosure, as described above, the page buffer circuit is divided into the first page buffer group 121 and the second page buffer group 122 which are respectively disposed on opposite sides of the bit line contact region BL_contact. Therefore, the bit lines BL1 to BLm are also divided into the even bit lines and the odd bit lines, and the odd bit lines (BL1, BL3, . . . , BLm−1) and the even bit lines (BL2, BL4, . . . , BLm) extend in opposite directions. Therefore, the semiconductor memory device may be designed such that sufficient distances are ensured between the bit lines BL1 to BLm.

The page buffers included in the first page buffer group 121 includes a cache latch 121_L including cache latches LATCH1 to LATCHm−1 for temporarily storing data. Each of the cache latches LATCH1 to LATCHm−1 may temporarily store data to be inputted from outside the peripheral circuit 140 in response to the first column select signal CS_odd during a program operation, or output temporarily-stored data outside the peripheral circuit 140 during a read operation.

The first column select decoder 131 is disposed in a region adjacent to the first page buffer group 121. That is, the bit line contact region BL_contact, the first page buffer group 121, and the first column select decoder 131 are successively arranged in one direction in the peripheral circuit region. The first column select decoder 131 generates and outputs first column select signals CS_odd to the first page buffer group 121 in response to first column address signals CADD_odd among column address signals to control the cache latches LATCH1 to LATCHm−1 of the first page buffer group 121.

The page buffers included in the second page buffer group 122 includes a cache latch 122_L including cache latches LATCH2 to LATCHm for temporarily storing data. Each of the cache latches LATCH2 to LATCHm may temporarily store data to be inputted from outside the peripheral circuit 140 in response to the second column select signal CS_even during a program operation, or output temporarily-stored data outside the peripheral circuit 140 during a read operation.

The second column select decoder 132 is disposed in a region adjacent to the second page buffer group 122. That is, the bit line contact region BL_contact, the second page buffer group 122, and the second column select decoder 132 are successively arranged in a direction opposite the one direction that the bit line contact region BL_contact, the first page buffer group 121, and the first column select decoder 131 are successively arranged in the peripheral circuit region. The second column select decoder 132 generates and outputs second column select signals CS_even to the second page buffer group 122 in response to second column address signals CADD_even among column address signals to control the cache latches LATCH2 to LATCHm of the second page buffer group 122. In one example, the first column select decoder 131, the first page buffer group 121, the bit line contact region BL_contact, the second page buffer group 122, and the second column select decoder 132 may be successively arranged in one direction in the peripheral circuit region.

According to the present disclosure, as describe above, the column decoder is divided into the first column select decoder 131 and the second column select decoder 132. The first column select decoder 131 and the second column select decoder 132 are respectively disposed adjacent to the first page buffer group 121 and the second page buffer group 122. Therefore, the column select signals may be divided into the first column select signal CS_odd and the second column select signal CS_even, and wires for transmitting the column select signals may also be divided into two parts. Therefore, the semiconductor memory device may be designed such that sufficient distances are ensured between the column select signal lines.

Furthermore, the column decoder is separated into the first column select decoder 131 and the second column select decoder 132, whereby the column address signals are divided into the first column address signals CADD_odd and the second column address signals CADD_even. Therefore, the semiconductor memory device may be designed such that distances between the column address signal lines are also sufficiently ensured. As a result, capacitance between the wires may be reduced, whereby the current consumption may be reduced.

FIG. 7 is a block diagram illustrating an arrangement of peripheral circuits according to an embodiment of the present disclosure.

Referring to FIG. 7, the first page buffer group 121, the second page buffer group 122, the first column select decoder 131, the second column select decoder 132 that are included in the peripheral circuit are disposed in a peripheral circuit region. In an embodiment, the peripheral circuit region is disposed under the memory cell array, as shown in FIG. 2.

The bit line contact region BL_contact electrically coupled with the bit lines of the memory cell array is disposed in a center portion of the peripheral circuit region.

The first page buffer group 121 and the second page buffer group 122 are disposed to face each other on opposite sides of the bit line contact region BL_contact, and the first column select decoder 131 and the second column select decoder 132 are disposed to face each other on opposite sides based on the bit line contact region BL_contact. That is, the first page buffer group 121 and the first column select decoder 131 are disposed on a first side of the bit line contact region BL_contact. The second page buffer group 122 and the second column select decoder 132 are disposed on a second side portion of the bit line contact region BL_contact opposite to the first side.

Of the bit lines BL1 to BLm, bit lines disposed adjacent to each other based on addresses are defined as a pair of bit lines. The first page buffer group 121 is electrically coupled to odd bit line pairs (for example, BL1 and BL2, BL5 and BL6, . . . , BLm−3 and BLm−2) among a plurality of bit line pairs coupled to the bit line contact region BL_contact, where BL1 and BL2 are a first bit line pair, and BL5 and BL6, are a third bit line pair, . . . etc. The second page buffer group 122 is electrically coupled to even bit line pairs (for example, BL3 and BL4, BL7 and BL8, . . . , BLm−1 and BLm) among the plurality of bit line pairs through the bit line contact region BL_contact, where BL3 and BL4 are a second bit line pair, BL7 and BL8 are a fourth bit line pair, . . . etc.

In an embodiment of the present disclosure, as described above, the page buffer circuit is divided into the first page buffer group 121 and the second page buffer group 122 which are respectively disposed on opposite sides of the bit line contact region BL_contact. Therefore, the bit lines BL1 to BLm are also divided into the odd bit line pairs (for example, BL1 and BL2, . . . , BLm−3 and BLm−2) and the even bit line pairs (for example, BL3 and BL4, . . . , BLm−1 and BLm). The odd bit line pairs (for example, BL1 and BL2, . . . , BLm−3 and BLm−2) and the even bit line pairs (for example, BL3 and BL4, . . . , BLm−1 and BLm) extend in opposite directions. Therefore, the semiconductor memory device may be designed such that sufficient distances are ensured between the bit lines BL1 to BLm.

The page buffers included in the first page buffer group 121 includes a cache latch 121_L including cache latches LATCH1, LATCH2, . . . , LATCHm−3, LATCHm−2 for temporarily storing data. Each of the cache latches LATCH1, LATCH2, . . . , LATCHm−3, LATCHm−2 may temporarily store data to be inputted from outside the peripheral circuit 140 in response to first column select signals CS_A during a program operation, or output temporarily-stored data outside the peripheral circuit 140 during a read operation. In an embodiment, the cache latches LATCH1, LATCH2, . . . , LATCHm−3, LATCHm−2 are cache latches included in a page buffer corresponding to the odd bit line pairs (for example, BL1 and BL2, . . . , BLm−3 and BLm−2).

The first column select decoder 131 is disposed in a region adjacent to the first page buffer group 121. That is, the bit line contact region BL_contact, the first page buffer group 121, and the first column select decoder 131 are successively arranged in one direction in the peripheral circuit region. The first column select decoder 131 generates and outputs first column select signals CS_A to the first page buffer group 121 in response to first column address signals CADD_A among column address signals to control the cache latches LATCH1, LATCH2, . . . , LATCHm−3, LATCHm−2 of the first page buffer group 121.

The page buffers included in the second page buffer group 122 includes a cache latch 122_L including cache latches LATCH3, LATCH4, . . . , LATCHm−1, LATCHm for temporarily storing data. Each of the cache latches LATCH3, LATCH4, . . . , LATCHm−1, LATCHm may temporarily store data inputted from outside the peripheral circuit 140 in response to second column select signals CS_B during a program operation, or output temporarily-stored data outside the peripheral circuit 140 during a read operation. In an embodiment, the cache latches LATCH3, LATCH4, . . . , LATCHm−1, LATCHm are cache latches included in a page buffer corresponding to the even bit line pairs (for example, BL3 and BL4, . . . , BLm−1 and BLm).

The second column select decoder 132 is disposed in a region adjacent to the second page buffer group 122. That is, the bit line contact region BL_contact, the second page buffer group 122, and the second column select decoder 132 are successively arranged in a direction opposite the one direction that the bit line contact region BL_contact, the first page buffer group 121, and the first column select decoder 131 are successively arranged in the peripheral circuit region. The second column select decoder 132 generates and outputs second column select signals CS_B to the second page buffer group 122 in response to second column address signals CADD_B among column address signals to control the cache latches LATCH3, LATCH4, . . . , LATCHm−1, LATCHm of the second page buffer group 122. In one example, the first column select decoder 131, the first page buffer group 121, the bit line contact region BL_contact, the second page buffer group 122, and the second column select decoder 132 may be successively arranged in one direction in the peripheral circuit region.

According to the present disclosure, as describe above, the column decoder is divided into the first column select decoder 131 and the second column select decoder 132 which are respectively disposed adjacent to the first page buffer group 121 and the second page buffer group 122. Therefore, the column select signals may be divided into the first column select signal CS_A and the second column select signal CS_B, and wires for transmitting the column select signals may also be divided into two parts. Therefore, the semiconductor memory device may be designed such that sufficient distances are ensured between the column select signal lines.

Furthermore, the column decoder is separated into the first column select decoder 131 and the second column select decoder 132, whereby the column address signals are divided into the first column address signals CADD_A and the second column address signals CADD_B. Therefore, the semiconductor memory device may be designed such that distances between the column address signal lines are also sufficiently ensured. As a result, capacitance between the wires may be reduced, whereby the current consumption may be reduced.

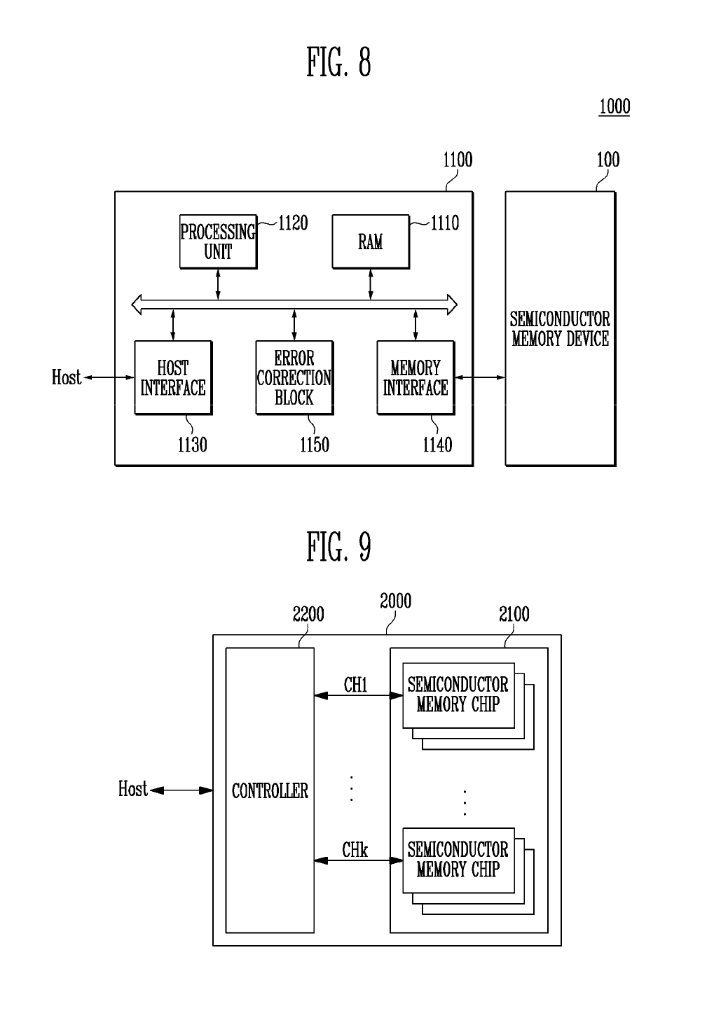

FIG. 8 is a block diagram illustrating a memory system including the semiconductor memory device of FIG. 1.

Referring to FIG. 8, the memory system 1000 includes the semiconductor memory device 100 and a controller 1100.

The semiconductor memory device 100 may have the same configuration and operation as those of the semiconductor memory devices described with reference to FIG. 1. Hereinafter, repetitive explanations will be omitted.

The controller 1100 is coupled to a host Host and the semiconductor memory device 100. The controller 1100 may access the semiconductor memory device 100 in response to a request from the host Host. For example, the controller 1100 may control read, write, erase, and background operations of the semiconductor memory device 100. The controller 1100 may provide an interface between the host Host and the semiconductor memory device 100. The controller 1100 may drive firmware for controlling the semiconductor memory device 100.

The controller 1100 includes a random access memory (RAM) 1110, a processing unit 1120, a host interface 1130, a memory interface 1140, and an error correction block 1150. The RAM 1110 is used as at least one of an operation memory of the processing unit 1120, a cache memory between the semiconductor memory device 100 and the host Host, and a buffer memory between the semiconductor memory device 100 and the host Host. The processing unit 1120 controls overall operation of the controller 1100. In addition, the controller 1100 may temporarily store program data provided from the host Host during the write operation.

The host interface 1130 includes a protocol for performing a data exchange between the host Host and the controller 1100. In an embodiment, the controller 1100 is configured to communicate with the host Host through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol, a private protocol, and the like.

The memory interface 1140 may interface with the semiconductor memory device 100. For example, the memory interface includes a NAND interface or NOR interface.

The error correction block 1150 uses an error correcting code (ECC) to detect and correct an error in data received from the semiconductor memory device 100. The processing unit 1120 may adjust the read voltage according to an error detection result from the error correction block 1150, and control the semiconductor memory device 100 to perform re-reading. In an embodiment, the error correction block may be provided as an element of the controller 1100.

The controller 1100 and the semiconductor memory device 100 may be integrated into a single semiconductor device. In an embodiment, the controller 1100 and the semiconductor memory device 100 may be integrated into a single semiconductor device to form a memory card. For example, the controller 1100 and the semiconductor memory device 100 may be integrated into a single semiconductor device and form a memory card such as a personal computer memory card international association (PCMCIA), a compact flash card (CF), a smart media card (SM or SMC), a memory stick, multimedia card (MMC, RS-MMC, or MMCmicro), a SD card (SD, miniSD, microSD, or SDHC), a universal flash storage (UFS), and the like.

The controller 1100 and the semiconductor memory device 100 may be integrated into a single semiconductor device to form a solid state drive (SSD). The SSD includes a storage device formed to store data in a semiconductor memory. When the memory system 1000 is used as an SSD, an operation speed of the host Host coupled to the memory system 1000 may be phenomenally improved.

In an embodiment, the memory system 1000 may be provided as one of various elements of an electronic device such as a computer, a ultra mobile PC (UMPC), a workstation, a net-book, a personal digital assistant (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture recorder, a digital picture player, a digital video recorder, a digital video player, a device capable of transmitting/receiving information in a wireless environment, one of various devices for forming a home network, one of various electronic devices for forming a computer network, one of various electronic devices for forming a telematics network, an RFID device, one of various elements for forming a computing system, or the like.

In an embodiment, the semiconductor memory device 100 or the memory system 1000 may be embedded in various types of packages. For example, the semiconductor memory device 100 or the memory system 1000 may be packaged in a type such as Package on Package (PoP), Ball grid arrays (BGAs), Chip scale packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), or the like.

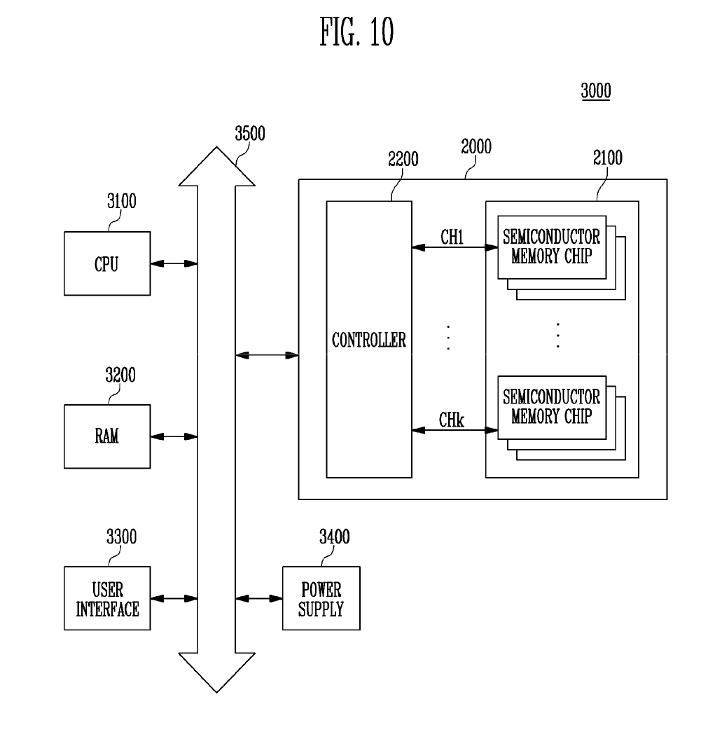

FIG. 9 is a block diagram illustrating an example of application of the memory system of FIG. 8.

Referring FIG. 9, the memory system 2000 includes a semiconductor memory device 2100 and a controller 2200. The semiconductor memory device 2100 includes a plurality of memory chips. The semiconductor memory chips are divided into a plurality of groups.

In FIG. 9, it is illustrated that each of the plurality of groups of memory chips communicates with the controller 2200 through first to k-ₜₕ channels CH1 to CHk. Each semiconductor memory chip may have the same configuration and operation as those of an embodiment of the semiconductor memory device 100 described with reference to FIG. 1.

Each group of memory chips communicates with the controller 2200 through one common channel. The controller 2200 has the same configuration as that of the controller 1100 described with reference to FIG. 8 and is configured to control a plurality of memory chips of the semiconductor memory device 2100 through the plurality of channels CH1 to CHk.

FIG. 10 is a block diagram illustrating a computing system including the memory system illustrated with reference to FIG. 9.

Referring to FIG. 10, the computing system 3000 may include a central processing unit 3100, a RAM 3200, a user interface 3300, a power supply 3400, a system bus 3500, and a memory system 2000.

The memory system 2000 is electrically coupled to the CPU 3100, the RAM 3200, the user interface 3300, and the power supply 3400 through the system bus 3500. Data provided through the user interface 3300 or processed by the CPU 3100 is stored in the memory system 2000.

In FIG. 10, the semiconductor memory device 2100 is illustrated as being coupled to the system bus 3500 through the controller 2200. However, the semiconductor memory device 2100 may be directly coupled to the system bus 3500. The function of the controller 2200 may be performed by the CPU 3100 and the RAM 3200.

In FIG. 10, the memory system 2000 described with reference to FIG. 9 is illustrated as being used. However, the memory system 2000 may be replaced with the memory system 1000 described with reference to FIG. 8. In an embodiment, the computing system 3000 may include all of the memory systems 1000 and 2000 described with reference to FIGS. 8 and 9.

According to an embodiment of the present disclosure, a peripheral circuit is disposed under a memory cell array of a semiconductor memory device, whereby the integration of the semiconductor memory device may be improved. The page buffers are divided into an even group and an odd group, and the even group and the odd group are disposed on opposite sides of a bit line contact region. As a result, a distance between bit lines, a distance between column select signal lines and a distance between column address signal lines may be ensured.

Examples of embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A semiconductor memory device comprising:
a memory cell array including a plurality of memory cells; and
a peripheral circuit disposed under the memory cell array,
wherein the peripheral circuit comprises:
a bit line contact region electrically coupled to the memory cell array;
a first page buffer group disposed on a first side portion of the bit line contact region; and
a second page buffer group disposed on a second side portion of the bit line contact region.

2. The semiconductor memory device according to claim 1, wherein the first page buffer group and the second page buffer group are respectively disposed on opposite sides of the bit line contact region.

3. The semiconductor memory device according to claim 1,
wherein the first page buffer group includes a plurality of page buffers, and
wherein the plurality of page buffers are respectively electrically coupled to odd bit lines among a plurality of bit lines coupled to the bit line contact region.

4. The semiconductor memory device according to claim 1,
wherein the second page buffer group includes a plurality of page buffers, and
wherein the plurality of page buffers are respectively electrically coupled to even bit lines among a plurality of bit lines coupled to the bit line contact region.

5. The semiconductor memory device according to claim 1,
wherein the first page buffer group includes a plurality of page buffers, and
wherein the plurality of page buffers are respectively electrically coupled to odd bit line pairs among a plurality of bit lines coupled to the bit line contact region.

6. The semiconductor memory device according to claim 1,
wherein the second page buffer group includes a plurality of page buffers, and
wherein the plurality of page buffers are respectively electrically coupled to even bit line pairs among a plurality of bit lines coupled to the bit line contact region.

7. The semiconductor memory device according to claim 1, wherein the bit line contact region is electrically coupled with bit lines of the memory cell array, and disposed in a center portion of the peripheral circuit region in which the peripheral circuit is disposed.

8. The semiconductor memory device according to claim 1,
wherein the peripheral circuit further comprises:
a first column select circuit disposed in a region adjacent to the first page buffer group; and
a second column select circuit disposed in a region adjacent to the second page buffer group.

9. The semiconductor memory device according to claim 8, wherein the first column select circuit and the second column select circuit are respectively disposed on opposite sides of the bit line contact region.

10. The semiconductor memory device according to claim 8,
wherein the first column select circuit outputs first column select signals to the first page buffer group in response to first column address signals among a plurality of column address signals including the first column address signals and second column address signals, and
wherein the second column select circuit outputs second column select signals to the second page buffer group in response to the second column address signals.

11. The semiconductor memory device according to claim 10,
wherein the first page buffer circuit includes a plurality of page buffers, and
wherein each of the plurality of page buffers includes a cache latch for temporarily storing data in response to the first column select signals.

12. The semiconductor memory device according to claim 10,
wherein the second page buffer circuit includes a plurality of page buffers, and
wherein each of the plurality of page buffers includes a cache latch for temporarily storing data in response to the second column select signals.

13. The semiconductor memory device according to claim 8, wherein the bit line contact region, the first page buffer group, and the first column select circuit are successively arranged in one direction in a peripheral circuit region in which the peripheral circuit is disposed.

14. The semiconductor memory device according to claim 13, wherein the bit line contact region, the second page buffer group, and the second column select circuit are successively arranged in a direction opposite to the one direction in the peripheral circuit region.

15. A semiconductor memory device comprising:
a peripheral circuit disposed in a peripheral circuit region formed on a semiconductor substrate; and
a memory cell array disposed over the peripheral circuit region,
wherein the peripheral circuit comprises:
a bit line contact region electrically coupled to the memory cell array;
a first page buffer group and a second page buffer group respectively disposed on opposite sides of the bit line contact region; and
a first column select circuit formed in a region adjacent to the first page buffer group, and a second column select circuit formed in a region adjacent to the second page buffer group.

16. The semiconductor memory device according to claim 15,
wherein the first page buffer group includes a plurality of first page buffers, and the plurality of first page buffers are respectively electrically coupled to odd bit lines among a plurality of bit lines coupled to the bit line contact region, and
wherein the second page buffer group includes a plurality of second page buffers, and the plurality of second page buffers are respectively electrically coupled to even bit lines among the plurality of bit lines coupled to the bit line contact region.

17. The semiconductor memory device according to claim 15,
wherein the first page buffer group includes a plurality of first page buffers, and the plurality of first page buffers are respectively electrically coupled to odd bit line pairs among a plurality of bit lines coupled to the bit line contact region, and
wherein the second page buffer group includes a plurality of second page buffers, and the plurality of second page buffers are respectively electrically coupled to even bit line pairs among the plurality of bit lines coupled to the bit line contact region.

18. The semiconductor memory device according to claim 15,
wherein the first column select circuit outputs first column select signals to the first page buffer group in response to first column address signals among a plurality of column address signals including the first column address signals and second column address signals, and
wherein the second column select circuit outputs second column select signals to the second page buffer group in response to the second column address signals.

19. The semiconductor memory device according to claim 18, wherein the first page buffer group temporarily stores data in response to the first column select signals, and the second page buffer group temporarily stores data in response to the second column select signals.

20. The semiconductor memory device according to claim 15, wherein the first column select circuit, the first page buffer group, the bit line contact region, the second page buffer group, and the second column select circuit are successively arranged in one direction in the peripheral circuit region.
